(19) United States
(12) Patent Application Publication
(10) Pub. No.: US 2024/0273510 A1
(43) Pub. Date: Aug. 15, 2024

(54) METHOD FOR PROCESSING A TRANSACTION, DEVICE AND CORRESPONDING PROGRAM

(71) Applicant: BANKS AND ACQUIRERS INTERNATIONAL HOLDING, SURESNES (FR)

(72) Inventors: Pierre QUENTIN, ENGHIEN LES BAINS (FR); Arnaud DUBREUIL, PARIS (FR)

(21) Appl. No.: 18/566,755

(22) PCT Filed: Jun. 3, 2022
(86) PCT No.: PCT/EP2022/065178

§ 371 Date: Dec. 4, 2023

(30) Foreign Application Priority Data
Jun. 4, 2021 (FR) FR2105933

(51) Int. Cl. G06Q 20/32; G06Q 20/40

(52) U.S. Cl. CPC G06Q 20/3278; G06Q 20/4012

(57) ABSTRACT

A method for executing a transaction between a transaction implementation terminal (TProf) and a communication device (Dton) which is located near the transaction implementation terminal (TProf). Such a method includes a step of preparing the transaction to be executed within the transaction implementation terminal (TProf), thereby outputting a set of intermediate transaction execution data; a step of transmitting the intermediate transaction execution data to the communication device (Dton); and a step of executing the transaction by the communication device (Dton) using the at least one item of intermediate transaction execution data and at least one item of personal data (Sgn, PIN) of the user who holds the communication device (Dton), such execution thereby outputting an execution result that is transmitted to the transaction implementation terminal (TProf).

### FIELD OF THE INVENTION

The invention relates to the field of protection of computer processes. The field of the invention relates more precisely to the protection of processes performed at least partly via two separate computer devices that are owned respectively by two entities that are also separate. The invention aims more particularly to protect the implementation of a confidential data process, for example during a transaction conducted between a device initiating the transaction and a device for at least partial execution of the transaction. The transactions targeted herein can be of various types, such as for example electronic signatures, access validations, payment transactions, data validation transactions.

### BACKGROUND

In the prior art, when a transaction has to be conducted for a beneficiary (i.e. merchant, notary, etc.), who is often a professional, this beneficiary requires the use, by a person (often a natural person), of a terminal dedicated to the transaction. This terminal is used by the person to confirm the transaction which is conducted, for example by applying a signature on this terminal or by entering a secret code, often after inserting, in this dedicated terminal, a transactional device held by the user (payment card, access card).

This way of implementing transactions poses a problem. Firstly, it poses a problem regarding the security of the data processed: few terminals can in fact guarantee the security of the data supplied by the user: both that supplied by the transactional device (payment card, access card) when it is inserted in the terminal of the professional beneficiary, or that entered by the user themselves to confirm their authorisation or their authentication, said confirmation being required to implement the transaction. The terminals which guarantee this security mainly include the payment terminals complying with the PCI standards.

However, due in particular to the digitisation of both the economy and the actions performed in everyday life, more and more acts and transactions are performed on terminals which firstly are not necessarily secure and which secondly are not terminals initially planned or designed to perform such transactions. For example, for the signature of notarised acts, digitised signatures, made by the user on an input tablet (of Wacom™ type for example) connected directly to the notary's computer, are used more and more frequently. Similarly, for the delivery of parcels, the recipient frequently has to apply their signature on a terminal of the delivery driver to validate reception of the parcel or letter which is delivered, without the user being aware or knowing the degree of security of the terminal presented to them. This is all the more true since the massive arrival of low-cost terminals, from production countries paying little attention to the quality of manufacture or security (software and hardware) of the terminals sold, exposes more and more people to attempts of fraud and confidence tricks by ill-intentioned individuals: these individuals take advantage of the security weakness of the terminals in circulation to inject malware applications, in order to obtain personal or confidential data.

In addition to these data security problems, there are recent problems related to health safety: in order to use devices supplied by professional beneficiaries, the latter must set up protocols to ensure personal safety. These protocols are often tedious and increase the time required to implement the transaction. A notary, for example, must clean the stylus used for the signature before it is used by any signatory. Similarly, professionals who have a payment terminal, or a signature terminal for the delivery of a letter or parcel, are theoretically obliged to apply a disinfecting solution on the terminal between each customer. In practice, these obligations are not necessarily fulfilled and they add a feeling of health insecurity to the actual presence of a certain transaction insecurity, depending on the situations encountered.

There is therefore a need to provide users with a method of making transactions which overcomes the problems posed, while ensuring the security of the data exchanged.

Solutions have been proposed, especially in the field of payment. Document U.S. Ser. No. 10/147,094B2 for example aims to propose a payment method based on the connectivity of a communication network to which a communication terminal of a user is connected, to allow this user to validate a transaction by entering a personal identification code associated with their communication terminal. The problem with this method is a means of payment (e.g. credit card) cannot be used to perform the transaction with the professional (e.g. the merchant). Document U.S. Ser. No. 10/127,532B1 describes a method for performing a payment transaction in which the communication terminal of the user is used to detect a payment intention and implement the transaction. However, this method for performing a transaction is based solely on the user's ability to want to initiate a payment transaction.

None of these solutions however can solve the problem of securing the implementation of the transaction from the point of view of the beneficiary professional (in particular, referring once again to the payment example, so that the natural person merchant ensures that the user has the ability to conduct the transaction) while guaranteeing to this user that the device used by the beneficiary professional does not unnecessarily receive confidential data (e.g. digitised signatures, confidential codes, etc.).

### SUMMARY OF THE INVENTION

The invention has been developed taking into account these problems of the prior art. More particularly, this disclosure relates to a method for executing a transaction between a transaction implementation terminal of a professional and a user communication device which is located near the transaction implementation terminal of the professional. Such a method comprises a step of preparing the transaction to be executed within the transaction implementation terminal of the professional, thereby outputting at least one item of intermediate transaction execution data; a step of transmitting at least one item of intermediate transaction execution data to the user communication device; and a step of executing the transaction by the user communication device using said at least one item of intermediate transaction execution data and at least one item of personal data of the user who holds the user communication device, said execution thereby outputting an execution result that is transmitted to the transaction implementation terminal of a professional.

Thus, unlike the prior art, the professional can check, during the construction, implementation and execution of the transaction, that the user has the ability and the means to perform this transaction. In turn, the user can ensure that the terminal of the professional does not receive personal information, in particular for example digitised signatures or passwords or confidential codes.

According to a special characteristic, the step of executing the transaction by the user communication device using said at least one item of intermediate transaction execution data and at least one item of personal data of the user who holds the user communication device comprises a step of obtaining, by the user communication device, at least one item of data from an additional transactional device held by the user.

Thus, the user can use their payment card directly on their communication terminal, in front of the merchant, who can check that their customer makes a payment using this payment card.

According to a special characteristic, the step of obtaining, by the user communication device, said at least one item of data from the additional transaction device held by the user comprises:
a step of issuing, by the user communication device, a request to obtain transactional data, said issuing step using a near-field communication interface of the user communication device;
a step of receiving, by the user communication device, a response to said request to obtain transactional data via a near-field communication interface of the user communication device.

Thus, the communication terminal of the user plays an active role in implementing the transaction, by requesting the transactional data itself.

According to a special characteristic, the step of executing the transaction by the user communication device using said at least one item of intermediate transaction execution data and at least one item of personal data of the user who holds the user communication device comprises:
a step of receiving said at least one item of intermediate transaction execution data by the user communication device;
   a step of dynamically configuring the user communication device, according to said at least one item of intermediate execution data, said step of dynamic configuration comprising a step of executing, within a dedicated memory space of said user communication device, a validation application for entering said at least one item of personal data of the user who holds the user communication device;
   a step of receiving, by the validation application, at least one item of data entered by said user;
   a step of validating, by the validation application, the transaction according to said at least one item of data entered by said user and said intermediate data, thereby outputting a validation result.

Thus, the user can enter the PIN code of their bank card, directly on their communication terminal.

According to a special characteristic, after the step of validating, by the validation application, the transaction according to said at least one item of data entered by said user and said intermediate data, the method comprises:
a step of transmitting said intermediate data and said validation result to a transactional server to which the user communication device is connected via the validation application,
a step of validating, by the transactional server, said intermediate data and said validation result, comprising a check of the validation cryptographic operations performed by said validation application;
a step of transmitting, to the transaction implementation terminal of a professional, said transaction validation result, when the check of the validation cryptographic operations outputs a positive result.

Thus, the transaction is processed in complete security, for example via the bank server corresponding to the user's bank or via that of the merchant, and this transaction can be processed immediately, without delay.

According to a special characteristic, the step of preparing the transaction to be executed within the transaction implementation terminal of the professional comprises:
a step of obtaining, via an additional transactional device held by the user, at least one encryption key intended to be transmitted to the user communication device; and
a step of inserting, within said at least one item of intermediate execution data, said at least one encryption key obtained.

Thus, the user can also choose to insert their bank card in the payment terminal of the merchant, when this is possible. The bank card pin code is nevertheless entered on the communication terminal of the user using data from their bank card, transmitted from the payment terminal of the merchant, which is technically reassuring for the merchant.

According to a special characteristic, the step of transmitting said at least one item of intermediate transaction execution data to the user communication device comprises:
a step of activating a communication interface of the transaction implementation terminal of a professional, for the transmission via a main channel;
a step of transmitting, via the communication interface, a file comprising said at least one item of intermediate data.

According to a special characteristic, the communication interface activated to transmit the file comprising said at least one item of intermediate data belongs to the group comprising:
a sound interface, configured to emit the previously encoded file in the form of an ultrasonic signal;
a screen of the transaction implementation terminal of a professional, configured to display the previously encoded file in the form of a two-dimensional code;
an interface for the transmission of data via a communication network, configured to transmit the previously encoded file in the form of a message.

According to another aspect, the invention also relates to a transaction execution system comprising a transaction implementation terminal of a professional and a user communication device which is located near the transaction implementation terminal of the professional. Such a system comprises means for preparing the transaction to be executed that are implemented within the transaction implementation terminal of the professional, thereby outputting at least one item of intermediate transaction execution data; means for transmitting said at least one item of intermediate transaction execution data to the user communication device; and means for executing the transaction that are implemented within the user communication device using said at least one item of intermediate transaction execution data and at least one item of personal data of the user who holds the user communication device, said execution thereby outputting an execution result and means for transmitting the execution result to the transaction implementation terminal of a professional.

According to a preferred implementation, the various steps of the methods according to the invention are implemented by one or more computer software packages or programs, comprising software instructions to be executed by a data processor of an execution device according to the invention, and being designed to control the execution of the various steps of the methods, implemented on a communication terminal, an execution electronic device and/or a control device, according to a distribution of the processes to be performed and determined by a scripted source code and/or a compiled code.

The invention therefore also relates to programs, likely to be executed by a computer or a data processor, these programs comprising instructions to control execution of the steps of the methods as mentioned above.

A program can use any programming language and may take the form of a source code, an object code, or an intermediate code between source code and object code, as in a partially compiled form, or in any other desirable form.

The invention also relates to an information medium that can be read by a data processor and comprising instructions of a program as mentioned above.

The information medium can be any entity or device capable of storing the program. For example, the medium can comprise a storage means, such as a ROM, for example a CD ROM or a microelectronic circuit ROM, or a magnetic recording means, for example a mobile medium (memory card) or a hard disk or an SSD.

In addition, the information medium can be a transmissible medium such as an electrical or optical signal, that can be routed via an electrical or optical cable, by radio or by other means. The program according to the invention can be downloaded in particular on an Internet type network.

Alternatively, the information medium can be an integrated circuit incorporating the program, the circuit being adapted to execute or to be used in the execution of the method concerned.

According to one embodiment example, the invention is implemented using software and/or hardware components. In this context, the term “module” can correspond in this document to a software component, a hardware component or a set of hardware and software components.

A software component corresponds to one or more computer programs, one or more sub-programs of a program, or more generally to any element of a program or software package adapted to implement a function or a set of functions, as described below for the module concerned. Such a software component is executed by a data processor of a physical entity (terminal, server, gateway, set-top-box, router, etc.) and may access the hardware resources of this physical entity (memories, recording media, communication buses, input/output electronic boards, user interfaces, etc.).

Similarly, a hardware component corresponds to any element of a hardware set adapted to implement a function or a set of functions, as described below for the module concerned. It may consist of a hardware component that is programmable or has a built-in processor to execute software, for example an integrated circuit, a smart card, a memory card, an electronic card to execute firmware, etc.

Obviously, each component of the system described above implements its own software modules.

The various above-mentioned embodiments can be combined together to implement the invention.

### BRIEF DESCRIPTION OF THE FIGURES

Other characteristics and advantages of the invention will appear more clearly on reading the description which follows of a preferred embodiment example given as a simple illustrative and non-limiting example, and referring to the attached drawings, in which:

FIG. 1 describes a system in which the disclosure can be implemented;

FIG. 2 describes the general principle of the method subject of the disclosure;

FIG. 3 illustrates an architecture of a professional electronic terminal adapted to implement a method subject of the disclosure.

### DETAILED DESCRIPTION OF THE INVENTION

As indicated previously, the disclosure describes a method consisting in requesting, from a communication device of a user, the at least partial implementation of a transaction which must be conducted on behalf of an initiator (for example a merchant, a notary, a delivery driver, an access validation device, etc.), who has or implements a user communication device (payment device, signature device, access control terminal etc.), considered for various reasons as presenting a security problem. In other words, a transaction execution dissociation technique is proposed: the transaction is initialised on a terminal of a professional and is completed (executed, finalised) on a terminal of a user, so that the latter can enter, in complete security, the confidential data required to validate this transaction.

Thus, so that the professional can ensure that the user can perform the transaction without providing personal and/or confidential data to the professional, the method consists in using a communication terminal of the user (typically their mobile communication terminal such as a smartphone or tablet) to execute a portion of the transaction initiated by the terminal of the professional. To do this, according to this disclosure, the terminal of the professional transmits special data to the terminal of the user, allowing the user terminal to continue executing the transaction. Continuing to execute the transaction may consist in validating it (for example by performing a signature operation and/or one or more cryptographic operations), or in checking the validation of confidential data.

Whatever the case, the main problem in the protocol modification proposed consists in particular: in ensuring the security of the data exchanged (to avoid its interception); in ensuring the non-repudiation of the data exchanged (to avoid any unwanted modification, both on the terminal of the professional and on the user terminal). It is in fact essential that the protocol modification does not induce any security breach allowing the transaction to be modified.

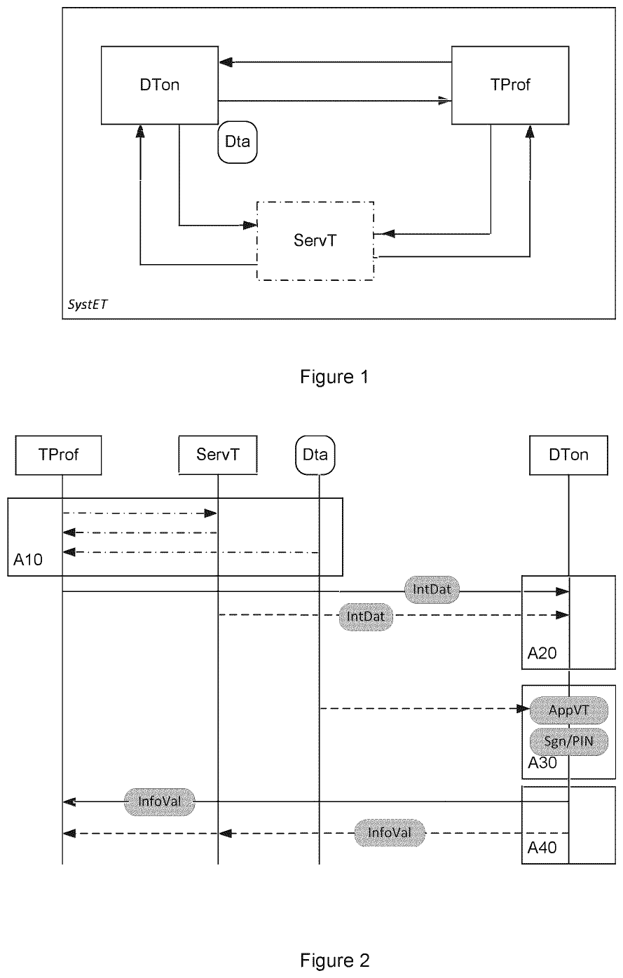

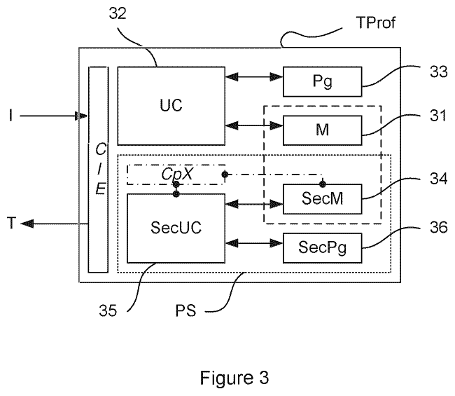

FIG. 1 describes a system in which the technique proposed can be implemented. Such a system (SystET) comprises a terminal of a professional (TProf), the terminal of the professional comprising transaction execution means. Such a terminal (TProf) is described in relation with FIG. 3. Such a system also comprises a user communication device (DTon), physical device belonging to a user and generally consisting of a tablet or a smartphone, this device being portable and available to the user when the user is physically on the premises or in the presence of the professional who uses the professional terminal (TProf). This system may also comprise, depending on the embodiments, a transactional server (ServT). In this case, the transactional server is at least accessible via a communication network for the professional terminal (TProf) and/or the user communication device (DTon). Depending on the embodiments, the system also comprises an additional transactional device (DTa) (access card, credit card) in particular when the transaction implementation requires the use of such an additional transactional device (transaction to access premises, payment transaction by bank card, credit card).

FIG. 2 describes the general principle of the method subject of the disclosure. More particularly, the method for performing a transaction comprises:
a step of preparing (A10) the transaction, implemented within the terminal of the professional (TProf); this step of preparing the transaction comprises, in particular, obtaining a (unique) identifier of the terminal of the professional; this unique identifier acts as a basis for initialising the transaction (it is stored/obtained within the terminal of the professional (TProf), or transmitted to the terminal of the professional (TProf) via the transactional server (ServT)); this step of preparing the transaction may also comprise obtaining data from an additional transactional device (DTa) when such a device is required to perform the transaction (this step of obtaining data comprises for example inserting a card held by the user in the terminal of the professional or obtaining contactless data between this card held by the user and the terminal of the professional); preparing the transaction may also comprise generating a transaction unique (pre-)identifier, in order to track and locate the transaction; the set {(“unique) identifier of the terminal of the professional”; “transaction unique (pre)-identifier” } forms intermediate data (IntDat); the data can be secured by encryption; preparing the transaction also comprises, depending on the operational implementation, other steps, as described later in the embodiments, which may comprise implementing other data to be transmitted to the user communication device (DTon), this other data being added to the set of intermediate data (IntDat); the intermediate data (IntDat) can be received, by the user communication device (DTon), either from the professional terminal (TProf) or via a transactional server (ServT);
once the transaction has been prepared (to various degrees, depending on the operational implementation), the user communication device (DTon) of the user is dynamically configured (A20), using the set of intermediate data (IntDat), received on the user communication device (DTon) of the user;
this transaction must then be validated (A30) (e.g. it must be executed/closed); validating the transaction comprises, for the user, interacting with a transaction validation application AppVT installed on their terminal: this interaction may comprise in particular entering one or more items of confidential data on the transaction validation application (digitised signature Sgn, confidential code PIN, etc.) and/or using on the user communication device (DTon) the additional transactional device (DTa) to obtain data from this device, when such a device is required to perform the transaction (whether or not this additional transactional device (DTa), when such a device is required to perform the transaction, has been used to prepare the transaction); the transaction validation application AppVT installed on the terminal is preferably executed in a secure space of the memory of the user communication device (DTon) and, preferably, this application is downloaded from a communication network only upon request, depending on the intermediate data received (i.e. the intermediate data received determines at least partly the configuration and execution of the transaction validation application AppVT) and is executed immediately after downloading in the random access memory of the user communication device (DTon); according to a variant, when the transaction validation application AppVT is already present (pre-downloaded by the user), it is configured depending on the intermediate data received; preferably, this transaction validation application AppVT prevents the use of the user communication device (DTon) by obtaining exclusive access to the execution resources of the user communication device (DTon) and limits the use of the latter to inputs on the touchscreen and optionally, to obtaining data via a near-field communication interface, when such an interface is required to execute (validate) the transaction; the transaction validation application AppVT is configured according to the intermediate data received: the intermediate data is used to build a data structure loaded in random access memory which limits execution of the transaction validation application, in particular as regards the communication interfaces to be used (ultrasound, camera, near-field, WAN, WLAN; the application is easy and straightforward to use and allows the input, validation, correction and cancellation—cancellation for example closes the application and unloads the data from the random access memory; the transaction validation application AppVT is built by the manufacturer of the professional terminal (TProf) (or an affiliate or a partner) to meet the specific validation requirements that this manufacturer wants to address: obviously, the application will not be the same to validate the reception of parcels or to validate an access transaction or a payment transaction; the application implements cryptographic operations (which are described below) and in particular encryption of the data entered by the user depending on the intermediate data (which may comprise encryption keys) or depending on the keys contained in the configuration of the application when it is downloaded and executed on the fly by the communication terminal.
Once the transaction has been validated, the user communication device (DTon) of the user communicates (A40) this validation information (InfoVal) to the terminal of the professional (TProf), either directly, by transmitting a relevant validation data to the latter, or indirectly, via the transactional server (ServT) which then communicates the validation data to the terminal of the professional. When a transactional server is used (which is not mandatory), the validation comprises a step of transmitting the intermediate data and the validation result to the transactional server to which the user communication device (DTon) is connected via the validation application (AppVT), then a step of validating, by the transactional server, the intermediate data and the validation result, comprising a check of the validation cryptographic operations performed by said validation application (AppVT) and a step of transmitting, to the transaction implementation terminal of a professional (TProf), the transaction validation result, when the check of the validation cryptographic operations outputs a positive result.

These four steps, implemented in an orderly manner within the system shown on FIG. 1, guarantee the security of the data entered by the user (this data is not provided as such to the professional) while guaranteeing to the professional, present when these steps are implemented, that the user is able to perform this transaction (i.e. that the user has the ability to do so and possibly has the tools required, i.e. the additional transactional device (DTa)). In addition, in a sensitive health climate, this implementation avoids the user having to touch the equipment of the professional.

FIG. 3 shows a simplified architecture of a professional electronic terminal (TProf) adapted to perform the transaction initiation processing as described previously. A professional electronic device comprises a first electronic module comprising a memory 31, a processing unit 32 equipped for example with a microprocessor, and controlled by a computer program 33. The professional electronic terminal may also comprise a second electronic module comprising a secure memory 34, which can be merged with the memory 31 (as shown in dotted lines, in this case the memory 31 is a secure memory), a secure processing unit 35 equipped for example with a secure microprocessor and with physical protection measures (physical protection around the chip, by lattice, vias, etc. and protection on the data transmission interfaces), and controlled by a computer program 36 specifically dedicated to this secure processing unit 35, this computer program 36 implementing all or part of the method for processing a transaction as described previously. The group composed of the secure processing unit 35, the secure memory 34 and the dedicated computer program 36 forms the secure module (PS) of the electronic device. In at least one embodiment example, this technique is implemented as a set of programs installed partly or totally on this secure portion of the transaction processing or initialisation terminal. In at least one other embodiment example, this technique is implemented as a dedicated component (CpX) capable of processing data of the processing units and installed partly or totally on the secure portion of the professional electronic terminal. In addition, the professional electronic terminal also comprises communication means (CIE) consisting for example of network components (WiFi, 3G/4G/5G, wire) allowing the professional electronic terminal to receive data (I) from entities connected to one or more communication networks and to transmit processed data (T) to such entities.

Such a professional electronic terminal comprises, depending on the embodiments:
means for obtaining data from the transactional devices presented by the users (access card, transaction card, etc.; these means may consist, for example, of a chip card reader, or contactless card readers of the NFC or RFID type);
entry means, allowing the professional to enter one or more data items to implement the transaction, whenever necessary (physical entry keyboard, screen, virtual entry keyboard);
means for processing the data obtained by the means for obtaining data from the transactional devices and means for processing the data entered by the professional; these means consist for example of a specific component;
means for processing a transaction, comprising transaction initialisation means;
means for supplying data to one or more transactional servers connected to the professional electronic terminal: these means typically consist of network communication interfaces, such as wired interface (RTC, Ethernet) or wireless interface (3G/4G, WiFi);
means for supplying data to a transaction implementation device, belonging to a user (e.g. smartphone, tablet): these means for supplying data may consist, for example, of a screen, on which this data is displayed, or an ultrasonic emission component (ultrasonic buzzer), or a near-field radio data emission component;

As explained previously, these means are implemented via modules and/or components, for example, but not necessarily secure. They thus ensure the security of the transactions performed while guaranteeing greater maintainability of the device.

The user communication device (DTon) generally consists of a mobile communication terminal (i.e. smartphone, tablet) which is held by the user when performing the transaction in the presence of the professional. Such a device further comprises the usual means, transaction implementation means, according to the method described previously. These means consist of an application executed on the terminal, enabling it to act as a user communication device (DTon). In a special embodiment example, this application is an application which is configured dynamically on the terminal of the user. More particularly, this application is configured dynamically upon reception, on the transaction implementation device, of the intermediate data comprising the unique identifier of the terminal of the professional and the unique transaction (pre-)identifier and, when necessary, an item of instantiation data. Upon reception of this data, the application is configured dynamically and executed. It displays for the user the data concerning the transaction (such as for example an identifier or a name of the professional concerned or other as described in the following embodiments).

Several embodiment examples of the method subject of the disclosure are described below.

### Embodiment Example 1: Delivery of a Parcel by a Delivery Driver

This embodiment example describes the execution of a dissociated transaction in the context of a delivery of a parcel by a delivery driver (professional) to a private individual (user). The delivery driver is equipped with a delivery electronic terminal (it is the terminal of the professional). In this embodiment example, once the administrative steps have been performed (i.e. the delivery driver has checked the user's identity, in particular, the user has inspected the condition of the parcel), the dissociated transaction processing is implemented, according to the steps described previously in relation with FIG. 2.

More particularly, in this embodiment example:
preparing the transaction by the terminal of the professional (delivery driver) comprises obtaining the terminal identifier within a memory of this terminal of the professional and preparing, by the processor, a transaction identifier; in addition, a data item representative of a location address (on the communication network or in an app store) of an instant application to be instantiated on the user communication device (i.e. the mobile terminal or the tablet) of the user is obtained, for example within the memory of the terminal of the professional, forming the set of intermediate data; a step of protecting at least some of this data is implemented: the terminal identifier and the transaction identifier are encrypted; a file for the transmission of this data is built using the set of intermediate data; the file for the transmission of this data may consist of: an image file, comprising a QR-Code or a modulated ultrasonic sequence; the image file is displayed on the terminal of the professional; the ultrasonic sequence is emitted from the terminal of the professional (note that these two ways of transmitting information to the user communication device can be implemented simultaneously); the transaction preparation is thus finalised; in this embodiment example, the QR-code or the modulated ultrasonic sequence represents the main intermediate data transmission channel;
The user communication device (the mobile terminal or the tablet) of the user receives the intermediate data file from the terminal of the professional (either by reading the QR-code or by receiving the ultrasonic sequence); the data is decoded (depending on the data encoding format used) and the user communication device (DTon) of the user is configured (dynamic configuration); a request is transmitted by the device of the user to the location address of an instant application with, as parameters, the data identifying the terminal of the professional and identifying the transaction; the instant application is immediately downloaded and executed on the user communication device (DTon); this instant application displays a user interface comprising: the information concerning the parcel, obtained from a transactional server (ServT) of the delivery company (or of another transactional server) and a signature area (allowing the user to sign with the finger or with a stylus on the touchscreen of their terminal) and three buttons (“cancellation”, “correction”, “validation”); this ends the dynamic configuration of the user device;
Then follows the step of validating the transaction, which consists for the user in applying their signature on the screen of their device (with a finger or a stylus), then validating this entry by selecting the “validation” button; a message is displayed for the user to inform them of the entry;
Once this entry/validation has been made by the user, the instant application validates the transaction by calculating a hash of the user's signature, by encoding the image of the signature using a key, obtained for example from the hash calculated, then by adding this data (hash of the signature, image of the signature) to the intermediate data; the set of resulting data is sent to the transactional server (ServT), and the instant application is deinstalled; the transactional server (ServT) receives the data transmitted by the instant application and transmits a message to the terminal of the delivery driver, informing them that the transaction has been validated.

Thus, thanks to this implementation, the user could receive their parcel, while avoiding firstly having to enter sensitive information on the terminal of the professional and secondly by securing the transmission of this data, in particular by encryption, to the transactional server. Similarly, the user does not have to touch the terminal of the professional, thus preserving the health safety. Equally, no application is permanently installed on the device of the user, since the instant application is installed only in the random access memory of the device of the user.

### Embodiment Example 2: Access to Premises Protected by an Access Terminal

This embodiment example describes the execution of a dissociated transaction when accessing protected premises, via a card access terminal (terminal of the professional), by a person wanting to access these premises (user). The terminal of the professional is equipped with a chip card reader, which is used by the user to access the premises. The access terminal can be connected to a communication network (for example a mobile network) and has data concerning the user (in particular a phone number, which it can use to transfer a notification to the terminal of the user).

The dissociated transaction processing is implemented, according to the steps described previously in relation with FIG. 2, after the user makes a request to access the premises (for example by inserting their access card in the access terminal reader, or by any means that can be used on the access terminal, such as a physical button for example):
preparing the transaction by the access terminal comprises obtaining the access terminal identifier within a memory of this terminal and preparing, by the processor, a transaction identifier; in addition, if not already done, a message prompting the user to insert their access card is displayed; the user then inserts their access card in the chip card reader; preparing the transaction then continues with the access terminal querying the access card, in particular to obtain a public key from the access card; this public key is inserted in the set of intermediate data; the set of intermediate data, after any additional checking operations (in particular, checking the validity of the access card), is then encrypted using a private key of the access terminal; a file for the transmission of this encrypted intermediate data is built and the file is transmitted to the terminal of the user via the communication network to which the access terminal is connected; in this embodiment example, the communication network represents the main intermediate data transmission channel;
the device DTon of the user receives the intermediate data file from the access terminal, for example via an SMS or another message transmitted on the communication network; the file data is decrypted using the public key of the access terminal (in addition, this public key was transmitted to the device (DTon), as explained below) and the user communication device (DTon) of the user is dynamically configured: a PIN code entry application with, as parameters, the data identifying the access terminal and identifying the transaction is executed on the user communication device (DTon); this application displays a PIN code entry user interface comprising: the information concerning the access, obtained from the intermediate data and a PIN code entry area (allowing the user to enter the confidential code of the access card that they inserted in the access terminal) and three buttons (“cancellation”, “correction”, “validation”); this entry application is for example pre-installed by the user or available natively on the user communication device (DTon); this ends the dynamic configuration of the user device;
Then follows the step of validating the transaction, which consists for the user in entering the PIN code on the screen of their device, then validating this entry by selecting the “validation” button; a message is displayed for the user to inform them of the entry;
Once this entry/validation has been made by the user, the application validates the transaction by encrypting the PIN code entered using a public key of the card present in the intermediate data received; this encrypted PIN is added to the decrypted intermediate data initially received, and the set is then encrypted with the public key of the access terminal; the set of resulting data is transmitted to the access terminal for example via an SMS type message and the PIN code entry application is stopped;
The access terminal receives the data transmitted by the application, decrypts it using its private key, checks that the intermediate data is correct and transmits the encrypted PIN code to the chip card inserted in the chip card reader of the access terminal; the chip card of the user decrypts the PIN code using its private key and checks that it is valid: if the PIN code entered is valid, the chip card can create a certificate intended for the access terminal in response to the validation request; the access terminal receives this certificate, checks it and authorises access to the premises.

Thus, thanks to this implementation, the user could access the premises protected by the access terminal, while avoiding firstly having to enter sensitive information on the access terminal and secondly by securing the transmission of this data, in particular by encryption, to the access server. Similarly, the user does not have to touch the access terminal, thus preserving the health safety.

For this implementation, it is assumed that the terminal of the user has the access terminal public key, which is communicated separately. To do this, several variants are considered. A first variant consists in installing the access terminal public key when configuring the communication terminal of the user: this configuration can be carried out by the authority which manages the access to the premises protected by the access terminal. This public key can be written in a certificate which is installed in a protected memory area of the communication terminal of the user. The advantage of this implementation is that it allows the authority which manages the access to the protected premises to ensure that each user terminal is identified and that the access terminal public key does not circulate unnecessarily.

A second variant consists in distributing the access terminal public key when implementing the dissociated transaction. In this case, the access terminal public key is transmitted to the communication terminal of the user on a transmission channel different from that used to transmit the intermediate data. This transmission channel is called an auxiliary channel and is used to secure the transmission of this public key. This auxiliary transmission channel may typically consist of a modulated ultrasonic signal, this signal encoding a data recording comprising firstly the access terminal public key (this public key can be a temporary session key) and secondly the conformity check data. In this second variant, the method for transmitting this public key is as follows: when the user inserts their access card in the access terminal card reader, the access terminal, during the step of preparing the transaction, distributes, using the auxiliary channel (i.e. the ultrasonic channel), the data recording comprising the access terminal public key. This distribution is only carried out after inserting the access card in the access terminal reader and after the access terminal has checked the validity of this access card (for example that it is not included on a list of banned cards, or that it is not deactivated—too old). The communication terminal of the user captures this distribution and acquires the data recording comprising the access terminal public key and the conformity check data. This distribution, by the access terminal, can be cyclic (i.e. repeated), until the access terminal transmits the intermediate data of the transaction to the communication terminal of the user (via the main channel, i.e. SMS or other transmission type on the communication network). The advantage of this implementation is that it allows the access terminal to define temporary keys that can only be used for a single transaction: in this case, in fact, the terminal public key is a session key and the corresponding private key is also a session key. Moreover, since the transmission of this key is only initiated from the time when the access card of the user is inserted in the access terminal reader, this key can be dedicated specifically to the access card of the user.

Depending on the embodiment variants, the roles of the communication channels can be inverted: the main channel can be the ultrasonic channel, used to transmit the intermediate transaction data, and the secondary channel can be the communication network, used to transmit the access terminal public key.

### Embodiment Example 3: Payment Using a Payment Terminal

This embodiment example describes the execution of a dissociated transaction when making a payment, via a card payment terminal (terminal of the professional), by a person wanting to make a payment for goods or services (user) at a merchant's. The terminal of the professional (payment terminal) is generally equipped with a chip card reader, which is not required in this embodiment example. The payment terminal is connected to a communication network (for example a mobile network or the communication network of the store, e.g. WiFi network, Ethernet) and can use data concerning the user (in particular a phone number, in the case of a loyalty account for example). Depending on the variants, it may be necessary to insert the payment card of the user in the payment terminal: in this case, the processing operations implemented are identical to the second embodiment example and the payment card chip is used in the chip card reader of the payment terminal to perform a payment transaction instead of an access transaction. In this third embodiment example, there is no need to insert the payment card in the payment terminal: the payment card is used by the communication terminal of the user DTon, as described below.

The dissociated transaction processing is implemented, according to the steps described previously in relation with FIG. 2, after the merchant makes a payment request (for example by requesting the user to pay for the goods or services):
preparing the transaction by the payment terminal comprises obtaining the identifier of the payment terminal (within a memory of this terminal or via the transactional server to which the payment terminal is connected, described below) and preparing, by the secure processor of the payment terminal, a transaction identifier; preparing the transaction also comprises adding, to the intermediate data, data corresponding to the amount of the purchases, date, time, etc.; the set of intermediate data, after any additional checking operations, is then encrypted using a private key of the payment terminal; a file for the transmission of this encrypted intermediate data is built and the file is transmitted to the terminal DTon of the user via the communication network to which the payment terminal is connected; in this embodiment example, the communication network represents the main intermediate data transmission channel;
the device DTon of the user receives the intermediate data file from the payment terminal, for example via an SMS or another message transmitted on the communication network; the file data is decrypted using the public key of the payment terminal (in addition, this public key was transmitted to the device DTon, as explained in the second embodiment example) and the user communication device (DTon) of the user is dynamically configured: a payment transaction validation application (for example, the bank application of the user pre-installed on their terminal) with, as parameters, the data identifying the payment terminal and pre-identifying the transaction, is executed on the user communication device (DTon); this application displays the transaction data for the user, as though the user was looking at the screen of the payment terminal; this entry application is for example pre-installed by the user or available natively on the user communication device (DTon); this ends the dynamic configuration of the user device;
Then follows the step of validating the transaction, which consists in the user:
   Positioning their payment card on the back of their communication terminal, which in this embodiment example is a contactless card (NFC); the bank card data is then read by the communication terminal of the user (card number, date, cw, name) and a user interface to enter the PIN code is displayed comprising: the information concerning the access, obtained from the intermediate data and a PIN code entry area (allowing the user to enter the confidential code of their payment card) and three buttons (“cancellation”, “correction”, “validation”);
   Entering the PIN code on the screen of their device, then validating this entry by selecting the “validation” button; a message is displayed for the user to inform them of the entry;
   Optionally, positioning their payment card again on the back of their communication terminal, so that the card checks the validity of the PIN code entered and supplies a transaction certificate.
Once this entry/validation has been made by the user, the application validates the transaction by generating a transaction certificate using the data from the bank card, and depending on the number of times the card has been positioned on the back of the communication terminal of the user; the transaction data and the transaction certificate are then transmitted to the transactional server;
The transactional server validates the transaction received from the communication terminal of the user and transmits data confirming the transaction to the payment terminal of the merchant;
The payment terminal receives the data transmitted by the transactional server: the merchant is then informed that the transaction has been validated.

Thus, thanks to this implementation, the user could pay for their purchases, while avoiding firstly having to enter sensitive information on the payment terminal (which, as mentioned previously, can be a simple communication terminal comprising payment functions for the merchant, such as for example communication terminals with additional Square™ type card readers, connected to the communication terminal) and secondly by securing the transmission of this data, in particular by encryption, to the transactional server directly, without going via the terminal of the merchant. Similarly, the user does not have to touch the terminal of the merchant, thus preserving the health safety.

### Embodiment Example 4: Payment Using a Payment Terminal

As in the previous embodiment example, the principle is once again to dissociate execution of the transaction by using three separate entities, as explained previously. The method is once again intended to allow a payment to be made between a physical merchant (i.e. located in a store) and a customer (user) also physically located in the merchant's store and wanting to pay for goods or services they are purchasing.

The dissociated transaction processing is implemented, according to the steps described previously, after the merchant makes a payment request (for example by requesting the user to pay for the goods or services).
The payment terminal obtains, from the transactional server, data concerning the bank with which the merchant is registered, in particular, an identifier related to the payment terminal, from an account of the merchant;
The payment terminal of the merchant transmits, to the device DTon, at least a “secure activation key” (or a pair of activation keys) which form the intermediate data, that is obtained in particular using the identifier related to the payment terminal; this key is transmitted, according to a first embodiment example, via a signal transmitted from the payment terminal of the merchant to the device DTon, which is located physically next to the merchant (and their payment terminal). (i.e. QR-Code or Ultrasound or “cloud transactional proxy, transactional server”, i.e. data transmission network);
   Reception of this/these key(s), acting as intermediate data, activates the application AppV on the communication terminal of the user. This application is pre-installed by the user, or it is the application of their bank, or it is a single-use instant application, as when receiving a parcel as described previously;
As well as receiving the secure activation key, the application AppV of the communication terminal of the user receives “the parameters of the merchant”, to be used to perform the transaction (which include in particular for example a “maximum amount”);
   A “maximum amount” is an amount, for example in euros, above which transactions by credit card must be authorised (i.e. be authorised by the bank card network).
   in this embodiment example, the transaction must be authorised by the network;
An acquiring service performs the transaction from a transactional server of merchant accounts (therefore from the bank) in relation with the communication terminal of the user and the application AppV, as explained previously;
A clearing service identifies, using the transactional data obtained, a method that can be used to validate the transaction; the transaction status is communicated to the (payment) terminal of the merchant and the credit (i.e. the sum of money) is written on the bank account of the merchant; this clearing service is performed from a transactional server of the bank of the merchant;
The terminal of the merchant receives, from the transactional server which performs the transaction (i.e. the server implementing the clearing service), a result of this transaction (consisting of an encrypted message). The transaction result is secured through the use of the activation key(s) transmitted to the communication terminal by the payment terminal.
   Thus, in this embodiment example, the consolidated method implemented is as follows:
A (prior) subscription step is implemented by the merchant (optional for the user, in particular for the customer's instant App);
The merchant selects the appropriate payment method on the payment terminal (and enters or receives the amount to be paid from the cash register);
depending on the operational implementation conditions, the user can insert their card in the payment terminal (for example depending on the amount of the transaction to be performed); the service implemented allows the customer to enter their PIN on their communication terminal;
The payment terminal receives information from the transactional server, in particular the transaction identifier and the key(s) for the transaction validation process; it requests this data from the transactional server;
The application of the communication terminal of the user is activated (and downloaded if it is an instant application)—activation can be manual (started by the user) or automatic (notification, i.e. background application, with data network of the communication terminal) or follow the transmission of information by the payment terminal of the merchant (QR-code scanned by the user, on payment terminal screen, ultrasounds emitted by the buzzer of the payment terminal and received by the communication terminal, NFC).
   As the same time as it is activated, the application of the communication terminal of the user receives the transaction identifier and the key(s) (either from the payment terminal of the merchant, or from the transactional server): if it is the transactional server, the latter is informed of the communication terminal via the identifier of the communication terminal of the user (for example their phone number).
On the basis of the transaction identifier and the key (or keys), the communication terminal of the user transmits a request to obtain transaction data and payment parameters (concerning the merchant) to the acquiring service (in particular to receive the maximum amount) of the transactional server;
   The device DTon then knows the amount to be paid and the merchant's identification: this ensures that the information displayed on the terminal of the merchant (and/or the cash register) is identical to that displayed on the communication terminal of the user;
   In other words, the transactional server comprises means for determining the transaction identifier and means for generating a key in order to exchange data securely with the communication terminal of the user on behalf of the merchant and it has a backup of the merchant's parameters as associated with the payment terminal of the merchant; the additional advantage offered is that the terminal of the merchant does not require any complex transaction processing functions, since these complex functions are managed by the transactional server and by the communication terminal of the user;
The application of the communication terminal then implements the transaction (as explained in the second and third embodiment examples).
The application of the communication terminal and the transactional server complete the EMV transaction.
Payment network processing is then implemented (card network): the transactional server transmits a transaction completion message to the clearing service (which transfers the transaction amount to the merchant's account);
The clearing service transmits the transaction completion message to the payment terminal of the merchant;
The transactional server also informs the application of the communication terminal that the transaction is completed.

1. A method for executing a transaction between a transaction implementation terminal of a professional (TProf) and a user communication device (DTon) which is located near the transaction implementation terminal of the professional (TProf), comprising a step of preparing the transaction to be executed within the transaction implementation terminal of the professional (TProf), thereby outputting at least one item of intermediate transaction execution data; a step of transmitting said at least one item of intermediate transaction execution data to the user communication device (DTon); and a step of executing the transaction by the user communication device (DTon) using said at least one item of intermediate transaction execution data and at least one item of personal data (Sgn, PIN) of the user who holds the user communication device (DTon), said execution thereby outputting an execution result that is transmitted to the transaction implementation terminal of the professional (TProf).

2. The method according to claim 1, wherein the step of executing the transaction by the user communication device (DTon) using said at least one item of intermediate transaction execution data and at least one item of personal data (Sgn, PIN) of the user who holds the user communication device (DTon) comprises a step of obtaining, by the user communication device (DTon), at least one item of data from an additional transactional device (DTa) held by the user.

3. The method according to claim 2, wherein the step of obtaining, by the user communication device (DTon), said at least one item of data from the additional transactional device (DTa) held by the user comprises:
a step of issuing, by the user communication device (DTon), a request to obtain transactional data, said issuing step using a near-field communication (NFC) interface of the user communication device (DTon);
a step of receiving, by the user communication device (DTon), a response to said request to obtain transactional data via a near-field communication (NFC) interface of the user communication device (DTon).

4. The method according to claim 1, wherein the step of executing the transaction by the user communication device (DTon) using said at least one item of intermediate transaction execution data and at least one item of personal data (Sgn, PIN) of the user who holds the user communication device (DTon) comprises:
a step of receiving said at least one item of intermediate transaction execution data by the user communication device (DTon);
a step of dynamically configuring the user communication device (DTon), according to said at least one item of intermediate execution data, said step of dynamic configuration comprising a step of executing, within a dedicated memory space of said user communication device (DTon), a validation application (AppVT) for entering said at least one item of personal data (Sgn, PIN) of the user who holds the user communication device (DTon);
a step of receiving, by the validation application (AppVT), at least one item of data entered by said user;
a step of validating, by the validation application (AppVT), the transaction according to said at least one item of data entered by said user and said intermediate data, outputting a validation result.

5. The method according to claim 4, wherein, after the step of validating, by the validation application (AppVT), the transaction according to said at least one item of data entered by said user and said intermediate data, the method comprises:
a step of transmitting said intermediate data and said validation result to a transactional server to which the user communication device (DTon) is connected via the validation application (AppVT),
a step of validating, by the transactional server, said intermediate data and said validation result, comprising a check of validation cryptographic operations performed by said validation operation (AppVT);
a step of transmitting, to the transaction implementation terminal of a professional (TProf), said transaction validation result, when the check of the validation cryptographic operations outputs a positive result.

6. The method according to claim 1, wherein the step of preparing the transaction to be executed within the transaction implementation terminal of the professional (TProf) comprises:
a step of obtaining, via an additional transactional device (DTa) held by the user, at least one encryption key intended to be transmitted to the user communication device; and
a step of inserting, within said at least one item of intermediate execution data, said at least one encryption key obtained.

7. The method according to claim 1, wherein the step of transmitting said at least one item of intermediate transaction execution data to the user communication device (DTon) comprises:
a step of activating a communication interface of the transaction implementation terminal of a professional (TProf), for transmission via a main channel;
a step of transmitting, via the communication interface, a file comprising said at least one item of intermediate data.

8. The method according to claim 7, wherein the communication interface activated to transmit the file comprising said at least one item of intermediate data belongs to the group comprising:
a sound interface, configured to emit a previously encoded file in a form of an ultrasonic signal;
a screen of the transaction implementation terminal of a professional (TProf), configured to display the previously encoded file in the form of a two-dimensional code;
an interface for the transmission of data via a communication network, configured to transmit the previously encoded file in the form of a message.

9. A system for executing a transaction, system comprising a transaction implementation terminal of a professional (TProf) and a user communication device (DTon) which is located near the transaction implementation terminal of the professional (TProf), comprising means for preparing the transaction to be executed that are implemented within the transaction implementation terminal of the professional (TProf), thereby outputting at least one item of intermediate transaction execution data; means for transmitting said at least one item of intermediate transaction execution data to the user communication device (DTon); and means for executing the transaction that are implemented within the user communication device (DTon) using said at least one item of intermediate transaction execution data and at least one item of personal data (Sgn, PIN) of the user who holds the user communication device (DTon), said execution thereby outputting an execution result and means for transmitting the execution result to the transaction implementation terminal of the professional (TProf).

10. A computer program product downloadable from a communication network and/or stored on a non-transitory computer-readable medium and/or executable by a microprocessor, comprising program code instructions to execute the method for executing the transaction according to claim 1, when it is executed on a computer.
